(19) United States
(12) Patent Application Publication
(10) Pub. No.: US 2005/0038558 A1
(43) Pub. Date: Feb. 17, 2005

(54) System and method for labeling pharmaceutical prescriptions

(76) Inventor: Astrid I.-S. Keene, San Francisco, CA (US)

Correspondence Address: CARR & FERRELL LLP, 2200 GENG ROAD, PALO ALTO, CA, 94303, US

(21) Appl. No.: 10/858,607

(22) Filed: Jun. 1, 2004

Related U.S. Application Data
(60) Provisional application No. 60/474,363, filed on May 30, 2003.

(51) Int. Cl. G06F 17/00; G07F 11/00

(52) U.S. Cl. 700/235

(57) ABSTRACT

The present invention provides a system and method for labeling pharmaceutical prescriptions. In accordance with various embodiments of the present invention, a label module compiles data and creates a customized medication label system for each medication or food supplement for a patient which is easy to understand due to the use of graphical representations of the medication or food supplement. The label system may further provide pictograms describing directions for use. A corresponding schedule may be generated will when used in conjunction with the label system reduces the possibility of mis-medication.

### CROSS-REFERENCE TO RELATED APPLICATIONS

The present application claims the priority and benefit of U.S. Provisional Patent Application Ser. No. 60/474,363 entitled “System and Method for Scheduling Pharmaceutical Prescriptions,” filed May 30, 2003, which is hereby incorporated by reference. The present invention is also related to co-pending patent application Ser. No. ______ entitled “System and Method for Scheduling Pharmaceutical Prescriptions” filed Jun. 1, 2004, which is incorporated by reference.

### BACKGROUND OF THE INVENTION

1. Field of the Invention

The present invention relates to healthcare and to the pharmaceutical field, and more specifically, to minimizing errors in prescribing, dispensing, and administering medication.

2. Description of Related Art

Recent studies by the U.S. Institute of Medicine show that nearly half of all American adults—90 million people—have difficulty understanding and using health information, and there is a higher rate of hospitalization and use of emergency services among patients with limited health literacy. Limited health literacy may lead to billions of dollars in avoidable health care costs.

A report released by the Journal of the American Pharmaceutical Association reports a typical pharmacy filling 250 prescriptions daily makes an average of four mistakes. An estimated 3 billion prescriptions will be prescribed and dispensed in 2004 (for 2005 the number is expected to be over 5 billion). That means that about 51.5 million errors occur just by dispensing medication each year, with 3.3 million of them potentially serious or deadly.

These and similar studies about medical and medicine errors are conducted in hospitals and other medical facilities, and therefore restrict the studies' focus on activities primarily performed by skilled personnel (doctors, nurses, pharmacists, etc.). These skilled personnel are highly educated and are equipped with the latest in technology and security systems to minimize errors in medicating patients. But after leaving the health-care system, patients are often left alone with an unfamiliar, complex medication schedule for administrating pharmaceuticals. Without doctors and/or skilled nurses available to supervise or assist patients, the often complicated, irregular medication plans make it extremely difficult for several risk groups, such as AIDS patients, senior citizens, persons with diminished capacities (i.e., mental and/or physical) including poor eyesight, and persons with limited or negligible knowledge of the written English language (or native language of a specific country in which they reside).

For example, AIDS patients are often faced with being prescribed complicated, often changing, irregular schedules to self-administer medication. Typically, a dozen or more medications are necessary every day to keep the patients' immune systems in balance. Depending on a patient's stage of the disease, additional medications may be required for each opportunistic infection. Furthermore, AIDS patients commonly become incapacitated suddenly, thereby requiring family, friends, and other nonprofessionals to step in and take over the medication administration at any time without training or any other specialized knowledge to ensure errors are minimized.

The number of prescription drugs per person has risen immensely during the last couple of years. The largest demographic group is comprised of senior citizens, who are typically aged 60 years or older. Seniors consume about 40% of prescribed drugs. Frequently, seniors are overwhelmed with their deteriorating health and/or simply can no longer deal with the sophisticated medication schedules. Regardless, seniors are vulnerable to the risks of mis-medication or over-medication, even if the patient resides in a retirement or convalescent home. Most retirement homes have established systems for prescribing, dispensing, and administering medication, but have not created an easily readable or understandable and secure system for preventing improper dosages or over-medication. Nursing personnel in such facilities may be less educated and understand little English, (or the native language of a specific country in which they reside) which exposes patients to additional risk of medical errors.

As a further example, patients with poor eyesight have difficulty reading prescription labels, and supplemental textual print-outs describing such medications are often too small to read. Moreover, the typefaces of the print on the labels are not user friendly. Oftentimes, specific instructions from the prescribing physician do not appear on the labels. Additionally, conventional administering systems are not suitable for patients who are blind, even if a patient can understand Braille.

Furthermore, patients with limited comprehension of the English language (or the native language of a specific country in which they reside) typically are at risk for errors because of a diminished ability to follow their own prescription schedules.

FIG. 1 shows an example of a conventional pharmaceutical label 100, which is typically found on a side of a pharmaceutical container. The conventional label 100 usually includes the name of the prescribed medication and simple directions for taking the medication. Typically, the name and the directions are in a native language of a pharmacy (or participant such as a physician or pharmacist). Thus, for example, prescribed medication dispensed in the United States will be in English. Disadvantageously, patients or caregivers who primarily language is not English will have difficulty in reading the convention label 100, which may, as a result, cause the patient to take the wrong medication or take the medication incorrectly (e.g., in a wrong amount, at a wrong time, etc.). Indeed, patients and caregivers who have a command of the English language may also have difficulties in reading and understanding the conventional label 100. Prescription names tend to be long, and in some instances can be easily confused with other prescriptions having similar names.

Therefore, there is a need for safeguard mechanisms to adequately reduce the risks prevalent in prescribing, dispensing, and administering medication.

### SUMMARY OF THE INVENTION

The present invention provides a system and method for labeling pharmaceutical prescriptions and food supplements, such as vitamins and minerals. In accordance with various embodiments of the present invention, a computer-implemented process as described herein reduces the risk of mistakenly taking or giving medication due, for example, to misreading a label on a medication container.

In one embodiment, a system and method is provided to manipulate data representing images and other information to generate, among other things, a label system for administering medication, food supplements, etc. In exemplary embodiments, the label system comprises a side label and a top label which clearly illustrates the medication and directions for use. For example, the system and method utilizes graphical representations (i.e., images) of prescribed medications and food supplements (e.g., minerals, vitamins, etc.) and pictograms when generating the label system. By working with visual images, a user can more quickly and easily recognize important information than if the information is provided only in text.

The pictograms and graphical representations, in exemplary embodiments, are provided by a medication reference and picture library, which is a database for all FDA approved medications and food supplements. Further, this database may allow for display of the graphical representations (i.e., images) at all angles and perspective views for more accurate identification of the medication. Animated images are available for 360 degree viewing if necessary to identify medications and food supplements.

For each of the pharmaceuticals, food supplements, and so forth stored in the Medication Reference and Picture-Library, dosage graduations, sizes, etc. are available. Changes in product appearance, dosages, and other information specific to an item (i.e., pharmaceutical, drug, medicine, food supplement, vitamin, or the like) can be updated quickly and at low cost over secure lines from the internet or other data carriers. In one embodiment, an automated voice feature pronounces the name of the medication and provides a brief description of usage to a participant (e.g., pharmacist, physician) to ensure that the correct medication is used in the label system.

The method and system further generates a corresponding schedule for pharmaceutical administration which utilizes the same graphical representations and pictograms found on the label system. The schedule is presented in a manner which allows the patient or caregiver to easily follow administration directions. By utilizing the schedule in conjunction with the label system, the patient or caregiver can verify that the right medication or food supplement is taken. Thus, the patient or caregiver may compare the medication with the graphical representation on the label system and with the graphical representation on the schedule. Additionally, pictograms on the label system and schedule provide directions for taking the medication.

In embodiments of the label system comprising a top label, the patient or caregiver may quickly determine the correct medication to take. This is advantageous when the patient has a large number of prescription medication. Typically, the medication will be grouped together in one central location, whereby only fops of all the medication containers are viewable. Advantageously, the top label of the present invention allows quick identification of the proper medication.

The medication reference and picture library can also include data representing machine-readable identifiers, such as a bar code, that are commonly used by the pharmaceutical industry, food supplement manufacturers, and advanced health care facilities for each medication unit to accommodate participants that have a bar code system. Each bar code represents a specific type of medication and/or patient specific prescription. These bar codes may be provided on the label system for easily reordering the medication or food supplement. The bar code is also suitable for scanner recognition systems used in advanced hospitals and healthcare facilities to identify a patient specific prescription.

### BRIEF DESCRIPTION OF THE DRAWINGS

FIG. 1 is a conventional pharmaceutical label;

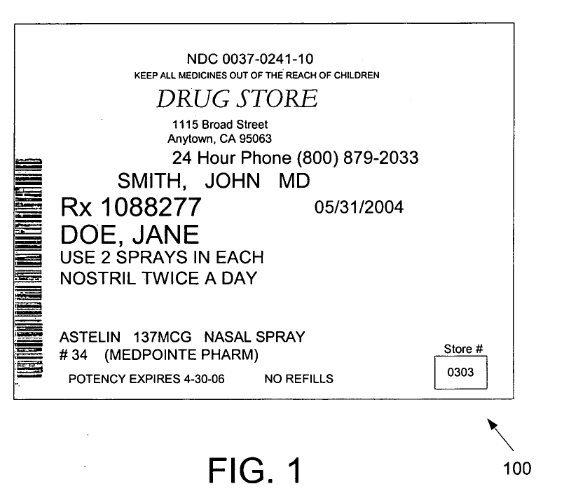

FIG. 2 is a diagram of an exemplary communications network suitable for implementing an embodiment of the present invention;

FIG. 3 is a diagram of the exemplary computing system of FIG. 2;

FIG. 4 is a diagram of the exemplary databank server of FIG. 2;

FIG. 5 is an exemplary medication provider schedule module, according to an embodiment of the present invention;

FIG. 6A is an exemplary pharmaceutical labeling system;

FIG. 6B is a table of exemplary pictograms;

FIG. 6C is an exemplary schedule which corresponds to the labeling system;

FIG. 7 is a flowchart of an overall method for generating a pharmaceutical label system, according to one embodiment of the present invention;

FIG. 8 is an exemplary flowchart for handling patient personal profile data;

FIG. 9 is an exemplary flowchart for creating patient personal medication and food supplement data;

FIG. 10 is an exemplary flowchart for testing crossover and allergic reaction;

FIG. 11 is an exemplary flowchart for creating patient personal administrative data;

FIG. 12A is an exemplary flowchart for generating the pharmaceutical label system;

FIG. 12B is an exemplary user interface page for label system generation;

FIG. 12C is an example printed label page, according to an exemplary embodiment of the present invention;

FIG. 12D is an exemplary medication information page;

FIG. 13 is an exemplary flowchart for utilizing the labeling system in conjunction with a corresponding schedule; and

FIG. 14 is an illustration of top labels of the present invention in use.

### DESCRIPTION OF EXEMPLARY EMBODIMENTS

The present invention provides a system and method for labeling pharmaceutical prescriptions and/or food supplements, such as vitamins and minerals. In accordance with various embodiments of the present invention, a computer-implemented process as described herein reduces the risk of mistakenly taking or giving medication at a wrong time or with a wrong dosage.

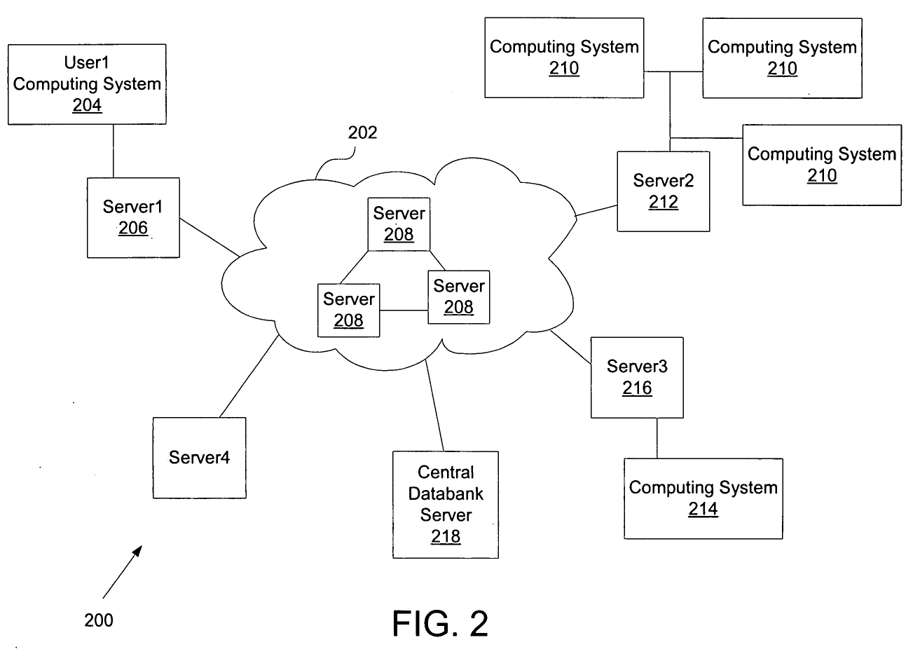

Referring now to FIG. 2, a generalized diagram of an exemplary network 200 in which the present invention may be practiced is shown. In FIG. 2, the network 200 comprises several local networks coupled to the Internet 202. Although specific network protocols, physical layers, topologies, and other network properties are presented herein, the present invention is suitable for use with any data communications network.

As shown in FIG. 2, a User1 computing system 204 is connected to a Server1 206 which in turn is coupled to the Internet 202. The User1 may be a network participant or a patient. The connection to the Internet 202 can be by a network, such as Ethernet, Asynchronous Transfer Mode, IEEE standard 1553 bus, modem connection, Universal Serial Bus, etc. The communication link need not be a wire but can be infrared, radio wave transmission, etc. The Internet 202 is shown symbolically as a collection of server routers 208. In an alternative embodiment, the User1 computing system 204 can be connected directly to the Internet 202. The connection of the Server1 206 to the Internet 202 is typically by a relatively high bandwidth transmission medium such as a T1 line, a T3 line, Metro Area Ethernet, or the like. Similarly, other computing systems 210 are shown utilizing a local network at a different location from the User1 computing system 204. The other computing systems 210 are coupled to the Internet 202 via a Server2 312. Similarly, a User3 computing system 214 and a Server3 216 represent yet a third installation.

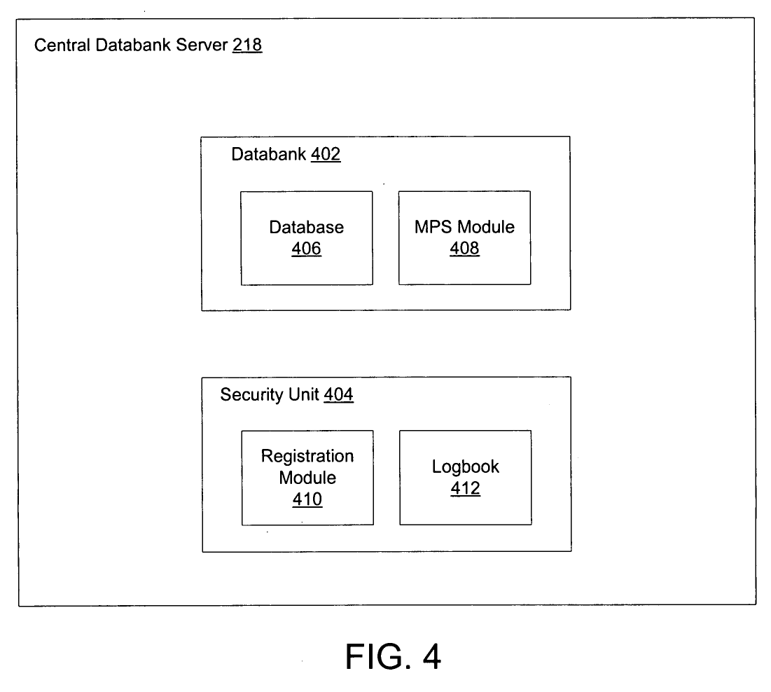

The network 200 further comprises a network central databank server 218 coupled to the Internet 202. The network databank server 218 is a high capacity server that stores network data such as every patient's personal data file. The databank server 218 will be discussed in further detail below in connection with FIG. 4.

Note that the use of the Internet for distribution or communication of information is not strictly necessary to practice the present invention but is merely used to illustrate a specific embodiment. Further, the use of server computers and the designation of server and client machines are not crucial to implementation of the present invention. For example, the present invention may be self contained within a LAN, or single computing system. Additionally, more users/participants and servers may be coupled to the network 200.

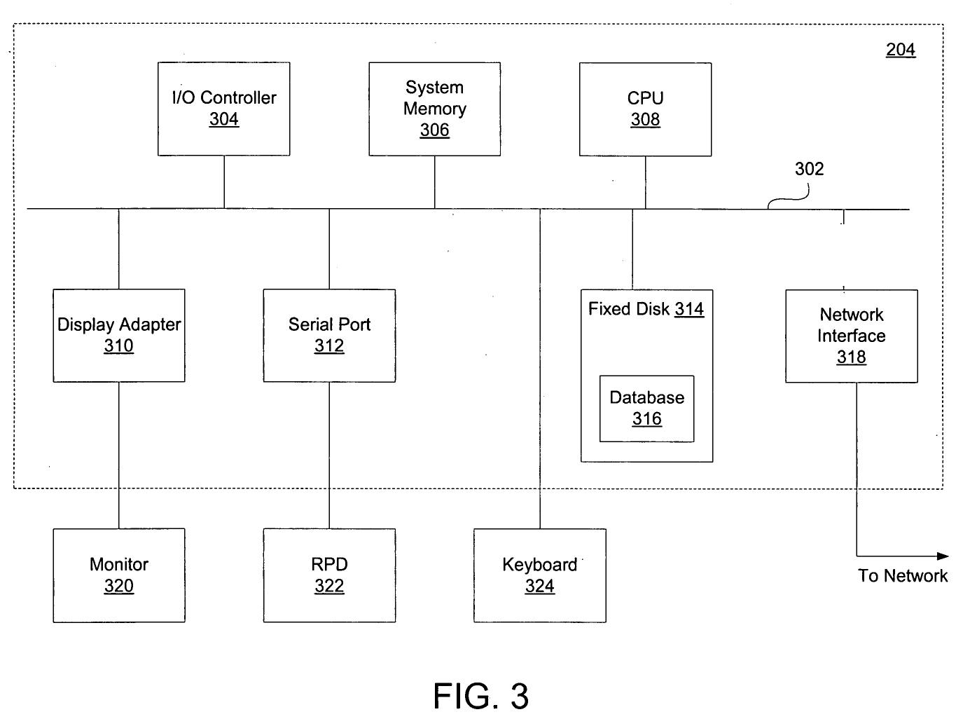

FIG. 3 illustrates the exemplary computing system 204 in more detail. In one embodiment, the computing system 204 comprises a plurality of components which are directly interfaced to an internal bus 302. The components include an input/output (I/O) controller 304, a memory 306, central processing unit (CPU) 308, a display adapter 310, at least one serial port 312, a fixed disc 314 comprising a database 316, and a network interface adapter 318, which in turn is coupled electrically to the network. The use of the bus 302 allows each of the components to transfer data among themselves and, most importantly, with the CPU 308. The CPU 308 may be a Sparc™, an Intel CPU, a PowerPC™, or other equivalent unit. Additionally, external devices can communicate with the CPU 308 or other components via the bus 302 by interfacing with one of the components coupled to the bus 302. Thus, a monitor/screen/display 320 couples with the display adapter 310, and a relative pointing device 322 (e.g. a touch screen or a mouse) couples through the serial port 312. Further devices such as a keyboard 324 may communicate with the CPU 308 by direct means as, for example, via an interrupt controller and associated registers. In exemplary embodiments, the database 316 may comprise a local databank (similar to a network databank) of patient information. In yet a further embodiment, a local databank may be externally coupled to the computing system 204.

It should be noted that the embodiment of FIG. 3 is exemplary. Components or devices in addition to or other than those shown in FIG. 3 may be utilized. Alternatively, a suitable computing system 204 can be achieved without using all of the components shown in FIG. 3. For example, a stand-alone computer need not be coupled to a network, so the network interface 318 is not required. Other components such as a CDROM drive, graphics accelerator, etc. can be included in the configuration without affecting the performance of the computing system 204.

Referring now to FIG. 4, the exemplary central databank server 218 is shown in more detail. The databank server 218 comprises a databank 402 and a security unit 404. The databank 402 comprises a database 406 and a medication provider schedule (MPS) module 408. In one embodiment, the databank 402 stores software (e.g., within the MPS module 408) for implementation of the present invention. Thus, a network participant (e.g., hospitals, doctors, pharmacies, and other professional health personnel) may download the software of the MPS module 406 over secure lines via the Internet 202 (FIG. 2) for storage and/or utilization on their local computing system 204. In a further embodiment, the participant does not need to have the software stored and/or loaded on their local computing system 204, but may work online over secure lines of the Internet 202 by running the software in the MPS module 408 directly on the databank server 218. Alternatively, the software may be read from a CD-ROM or other storage medium. When upgrades to the system (e.g., upgrades to modules of the MPS module 406) are required, the participant may obtain the upgrades via the same methods (e.g., download over the Internet 202 from the network databank server 218).

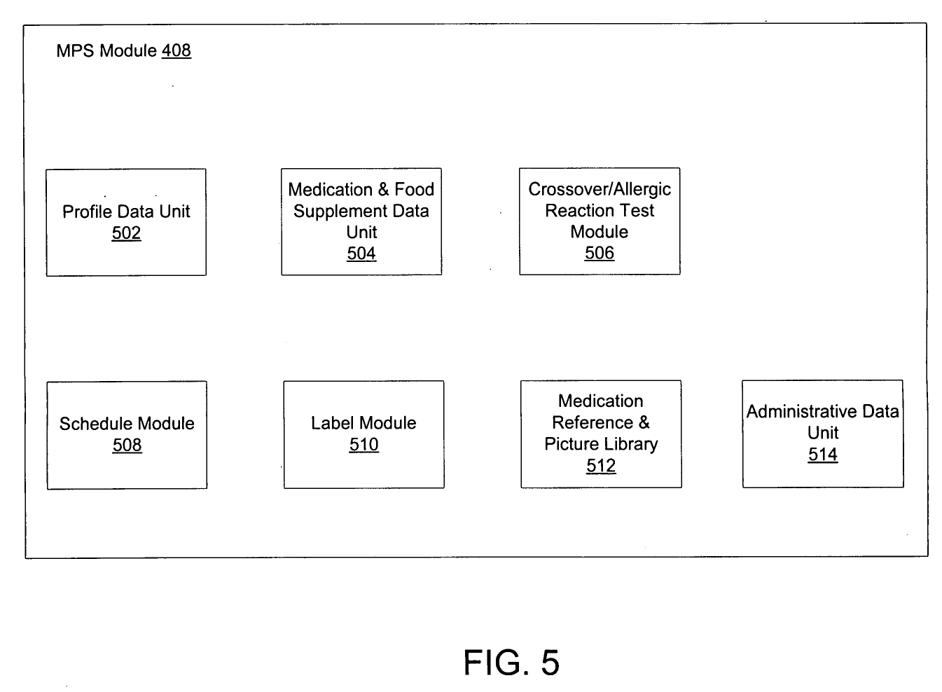

The MPS module 408 further comprises components which create data files utilized by the system in order to generate the medication labels of the present invention. This aspect of the MPS module 408 will be discussed in more detail in connection with FIG. 5.

In order to access the databank 402, the participant must register with, and provide a correct login to a registration module 410 of the security unit 404. According to one embodiment, the participant will receive or set an ID number (or login name) and a password after a first registration with the security unit 404. Subsequently upon entering the login name and password and verification by the registration module 410, the participant may access the databank 402 to exchange information with the database 406; or to work off the databank server 218 (instead of having the software loaded on the participant's computer). A logbook 412 records all access to the databank server 218 including all activities, data entry, user names, and locations. In a further embodiment, a patient may access their own records stored on the databank server 218 via the Internet 202. These patient accesses may also be logged in the logbook 412.

The database 406 of the databank 402 stores patient data files. Initially, the patient authorizes the participant to establish his/her personal data file. The data in the file may include personal profile data such as full name of patient, social security number (which may be encoded for protection), date of birth, place of birth, picture of the patient, sex, allergies, health insurance, medical records, etc. Additionally, data may be stored for a patient's personal medications and food supplements and for a personal illustrated schedule. Further embodiments may store other forms of information in the database 406. The participant may receive or enter the data via their user computing system (e.g., 204). Alternatively, data can be provided or received via cell phone, palm, or other computing devices.

In exemplary embodiments, the patient's data file may be stored at the local computing system database 316 (FIG. 3) or other local databanks, in addition to, or instead of being stored at the network databank 402. This allows the participant to work offline. In these embodiments, access by the participant on their computing system 204 and activation of the corresponding software may result in an entry in the logbook 412 on the databank server 218 or a similar logbook of the local databank. This insures that a complete access record is kept.

Referring now to FIG. 5, the MPS module 408 is shown in more detail. As previously discussed, the modules of the MPS module 408 may be downloaded and stored locally for use on a computing system, or accessed for operation on the central server 218 (FIG. 2). The exemplary MPS module 408 comprises a patient profile data unit 502, a medication and food supplement data unit 504, a crossover/allergic reaction test (Drug Utilization Review, DUR) module 506, a schedule module 508, a label module 510, and a medication reference and picture library 512. In alternative embodiments, more, less, or other modules and units may be embodied in the MPS module 408. For example, a further embodiment may comprise an optional administrative data unit 514 which uses data such as bar codes, RX refill numbers, refill due dates, and number of refills to create an administrative data file used for populating a label system and/or a corresponding schedule, according to the present invention.

The profile data unit 502 creates and maintains a patient's personal profile. The personal profile may comprise data such as patient name, social security number (which may be encoded for protection), date of birth, place of birth, a picture of the patient, sex, allergies, health insurance information, medical records, and any other information relevant to the patient's medical condition and treatment. This information may be received from the patient, the participant, or the database 406 (FIG. 4).

The medication and food supplement data unit 504 uses information such as name of medication, dosage, amount, directions, time of allocation, and so forth to establish a complete list of all medications and food supplements for a particular patient. The information may be supplied by the patient, supplied by the participant, or obtained from the database 406.

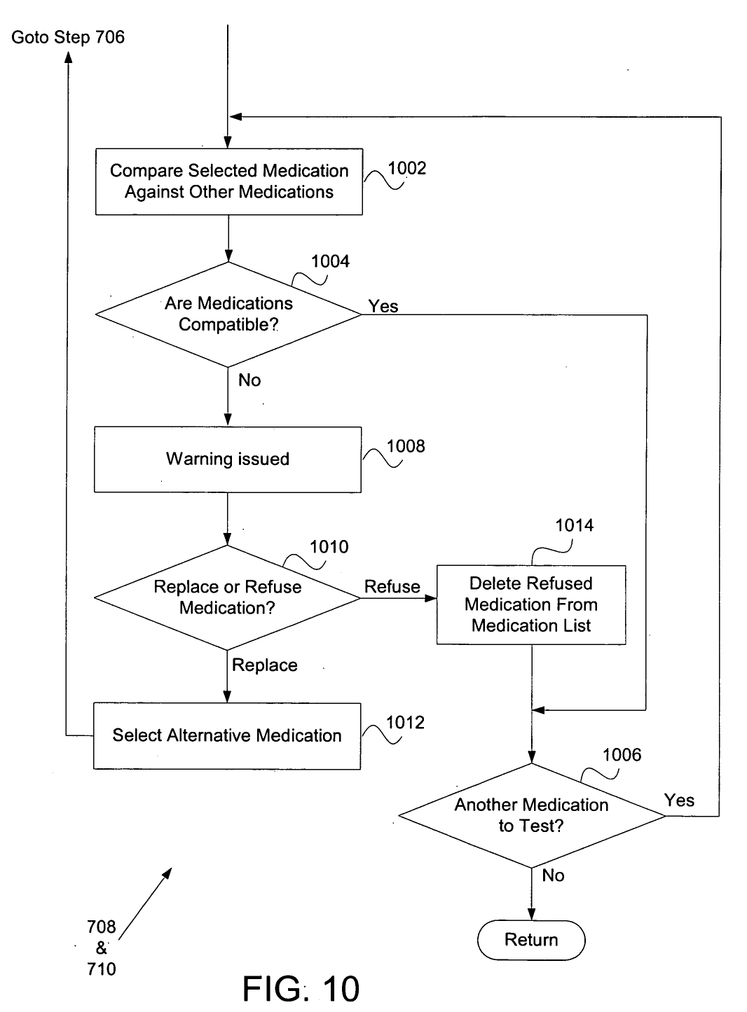

The crossover/allergic reaction test (DUR) module 506 checks prescribed and/or self-administered medications and food supplements, such as vitamins and minerals, taken by the patient to insure no adverse effects will occur. If an adverse effect will occur, the system will, in exemplary embodiments, access the medication reference and picture library 512 for recommendations for an alternative medication. The crossover/allergic reaction test will be discussed in more detail in connection with FIG. 10

Based on the data obtained and/or created by the profile data unit 502, the medication and food supplement data unit 504, the crossover/allergic reaction test module 506, and the optional administrative data unit 514, the schedule module 508 generates a medication schedule for the patient. The schedule module 508 (FIG. 5) generates this schedule by organizing all the provided information into a suitable format form for each individual patient based on the patient's and/or caregiver's needs and abilities. In exemplary embodiments, the schedule module 508 uses color images/illustrations such as photos or elucidated drawings of medication/food supplements or the like to clearly identify such medications. Further, directions or warnings for taking of the medication can be illustrated through the use of pictograms. Additionally, the pictogram can be supplemented with further directions such as, but not limited to, “take with food,” “take with water,” “do not take with alcohol.” The schedule generation process is discussed in further detail in the co-pending patent application Ser. No. ______.

In a corresponding process, labels for the medication are generated by the label module 510. These labels will coordinate with the schedule. For example, both the schedule and the label use the same illustrations and pictograms for the medication, directions, and warnings, thus allowing the patient to match the correct medication to the bottle/container and to the schedule. This diminishes the possibility that the patient will take the wrong medication.

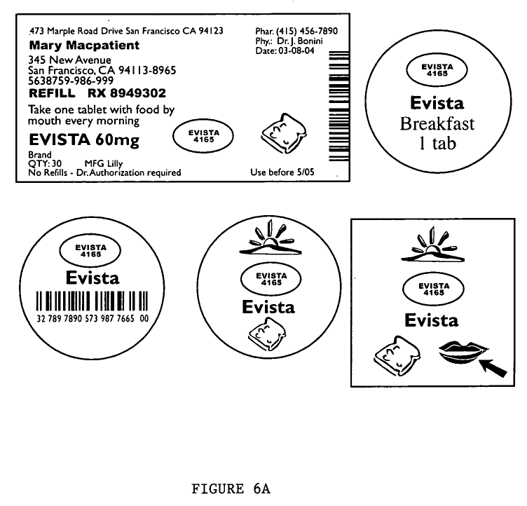

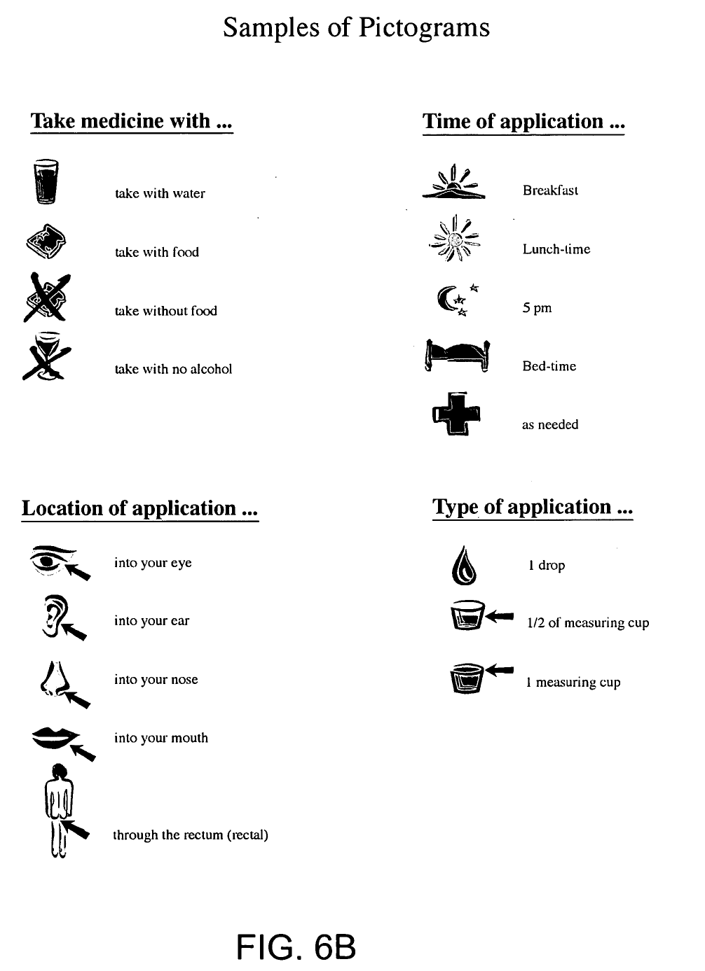

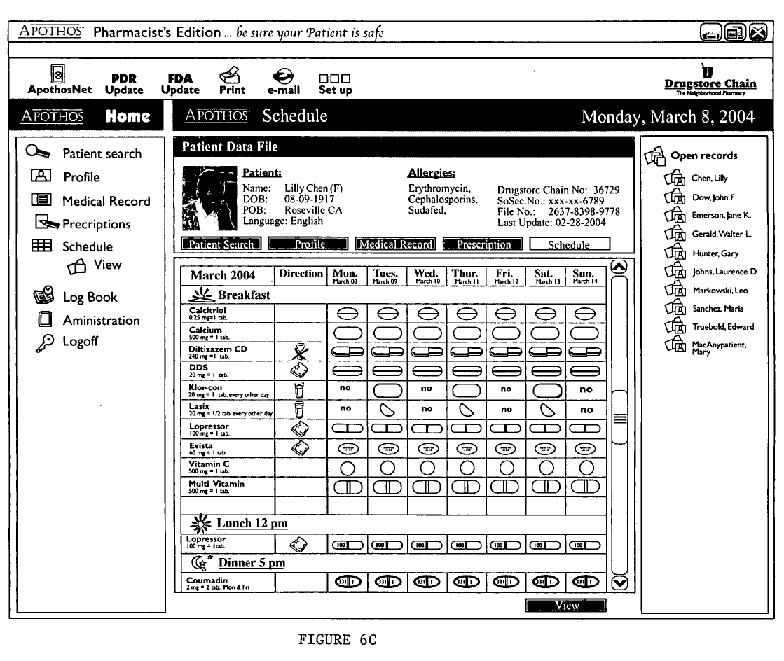

Referring now to FIG. 6A, exemplary pharmaceutical labels are shown. The sample labels comprise various top labels 602-608 (for application to a top of a container) and a side label 610 (for application to a side of the container), and may be utilized in any combination thereof (e.g., the side label 610 with the top label 602). According to the present embodiment, the top labels 602-608 provide an illustration or graphical representation 612 of the medication or food supplement contained within the labeled container. The top labels 602-608 may further provide a name 614 of the medication or food supplement and a time indicator 616, 618 for when the medication or food supplement should be taken. In the top label 602, the time indicator 616 is textual. In the present example, the time indicator 616 is listed by the corresponding meal with which the medication or food supplement should be taken in conjunction. Alternatively, the time indicator 610 may specify an actual time (e.g. 10 a.m.), time period (e.g., morning, afternoon, or night), or any other indication of time. Alternatively, the top labels 606 and 608 illustrate the time indicator 618 with pictograms (e.g., rising sun image represents breakfast). Additionally, the top labels 602-608 may provide an amount 620 of medication or food supplement to be taken. Further, the top label 604 may comprise a bar code 622 which may be used for refills or in scanner recognition systems used in advanced hospitals and healthcare facilities, to identify a patient specific prescription (e.g., scan a wristband of a patient and than the medication label to verify correct medication). In further embodiments, the top labels (e.g., 606 and 608) further comprise pictograms 624 which illustrate use directions. (e.g., bread image represents taking medication with food, while the mouth and arrow image represents that the medication should be taken orally).

The exemplary side label 610 also provides the patient or caregiver with both graphic and textual information. A graphical representation 626 of the medication or food supplement identical to the graphical representation 612 found on the top labels 602-608 is provided. Further, pictograms 628 may be provided on the side label 610 which provide additional information to the patient or caregiver. In the present example, one pictogram 628 is presented on the side label 610. This pictogram 628 represents directions that the medication should be taken with food. An exemplary table of some applicable pictograms is shown in FIG. 6B. Pictograms in addition to those shown in the table are contemplated and may be used in accordance with the present invention. Additionally, more than one pictogram 628 may be provided on the side label 610. In further embodiments, corresponding pictograms may be presented on the top label 606 or 608 as well. In exemplary embodiments, the side label 610 may further comprise a bar code 630 having a same functionality of that of the bar code 622 on the top label 604.

In further embodiments, the labels 602-610 may be presented to the patient or the caregiver in a different manner based on the needs of the patient or the caregiver. For example, the labels 602-610 may be in a native language of the patient or caregiver, print may be enlarged for patients with poor eyesight, or the label systems 600 may be present in Braille for partially or fully blind patients.

If should be further noted that the labels 602-610 of FIG. 6A are exemplary. The labels 602-610 may comprise different shapes or sizes based on, for example, container size, print size, and other patient/caregiver needs. Further, any combination of graphical representations, pictograms, and/or textual information may be utilized in the top and side labels.

In exemplary embodiments of the present invention, the labels 602-610 work in conjunction with a corresponding pharmaceutical prescription schedule. An exemplary schedule 640 is shown in FIG. 6C (as displayed on a monitor 320 of FIG. 3), which may be provided (e.g., printed, transmitted as an electronic version or any other way) to the patient or caregiver. According to exemplary embodiments, the schedule 640 is a table describing times and procedures to take prescribed medications and/or food supplements (e.g., what time, which medication, how much of the medication, etc.).

The presentation of the schedule 640 can be varied so as to adapt to a patient's/caregiver's specific needs (e.g., it can be organized by day, hour, type of medication, frequency of use, before or after meals, or any other way). The presentation type depends on an ability of the patient and/or the place/institution the schedule 640 will be used. The schedule 640 especially supports patients with special needs, temporary or permanent disabilities (e.g., patients whose conditions force them to take a great number of drugs, complicated drug patterns and combinations), patients with low vision or blindness (e.g., using Braille), patients with limited language comprehension, etc. The schedule 640 can include illustrations of the medications for identification, and uses such illustrations in the form of images and/or photos (e.g. color) or detailed drawings of one or more medications to support a clear identification for patients with sight. In a further embodiment, the schedule 640 also can be adapted to include audio descriptions and/or Braille representations of a medication if the patient has negligible sight, or is blind.

The schedule 640 shows medication that the patient must take with breakfast (i.e., in the morning), lunch, and dinner. This exemplary schedule 640 is provided for one week. However, alternative embodiments may be generated to show the schedule for the entire day (e.g., by meals such as breakfast, lunch, and dinner; by times such as hourly increments; etc.), and the schedule 640 may comprise other time periods (e.g., for two weeks, for the month). As shown, the schedule 640 clearly illustrates to the patient or administrator the medication name and look (i.e., graphical representation 642) as well as whether the medication should be taken on a specific day. Ideally, the graphical representation 642 for a same medication or food supplement will be identical to that found on the corresponding label or labels 602-610 (FIG. 6A). Thus, the patient or caregiver can easily compare the schedule 640 with the label (e.g., the top label 602) and quickly determine which container contains the correct medication or food supplement based on the graphic representations 642, 612, and/or 626.

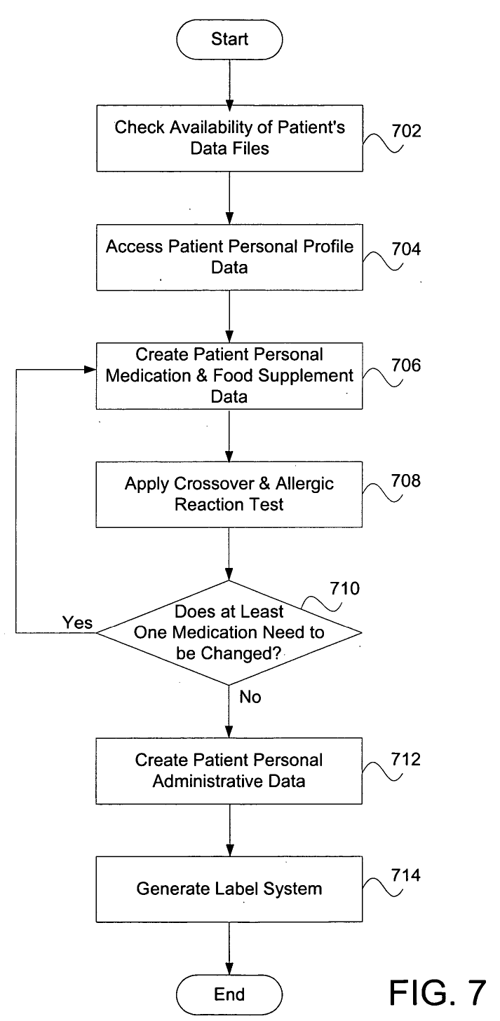

Referring now to FIG. 7, an exemplary flowchart of one method for generating the labels 608-610 (FIG. 6A) is shown. In step 702, the participant checks the availability of a particular patient's data files. According to one embodiment, the participant accesses the local MPS module (i.e., the local MPS module on the computer system 204 of FIG. 2), and checks for availability of the patient's personal data file in the local databank. The participant may also log onto the network central databank 218 (FIG. 2) by providing an authorized user name and password which is verified by the security unit 404 (FIG. 4). Data or data updates for the particular patient's data file may then be transferred from the central databank 402 to the participants computing system 204 (FIG. 2) and stored in the local databank or database 316 (FIG. 3). These updates may comprise information from other participants on the network. For example, the patient may have different physicians with different specialties. Each physician may write prescriptions locally and the central databank 402 collects all the information. In one embodiment, the computing system 204 is a server located on premises of the participant, and operates, among other things, to store patient personal data files established on the premises and/or retrieved from the network central databank 218. The personal data files include the patient's personal profile data, existing patient's personal medication and food supplement data, and existing patient's personal illustrated provider schedule data.

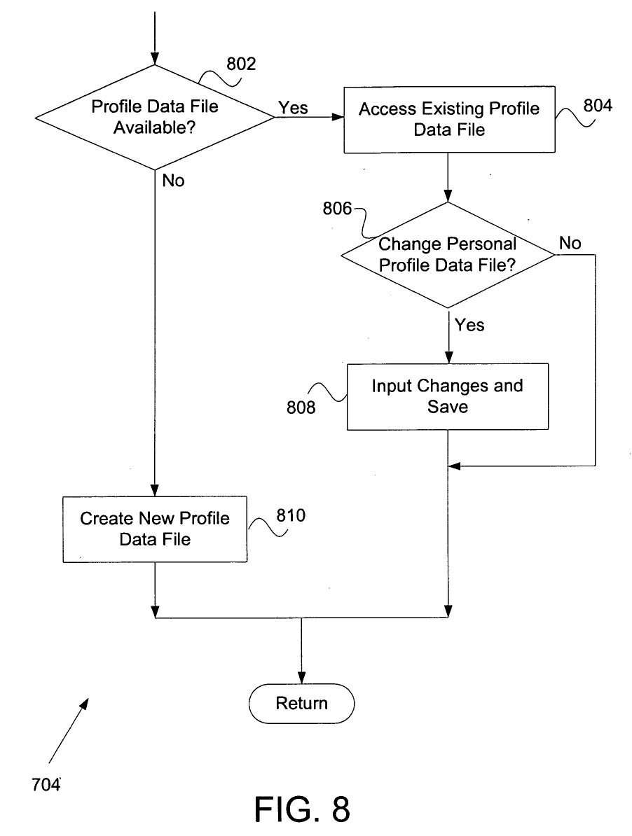

In step 704, the participant accesses the patient's existing personal profile data. The participant may view and/or update the existing personal profile data, which may be established previously by another participant. If the personal profile data is not available (e.g., not previously established), the participant may create a new personal profile data file via the profile data unit 502 (FIG. 5). This step will be discussed in more detail in connection with FIG. 8.

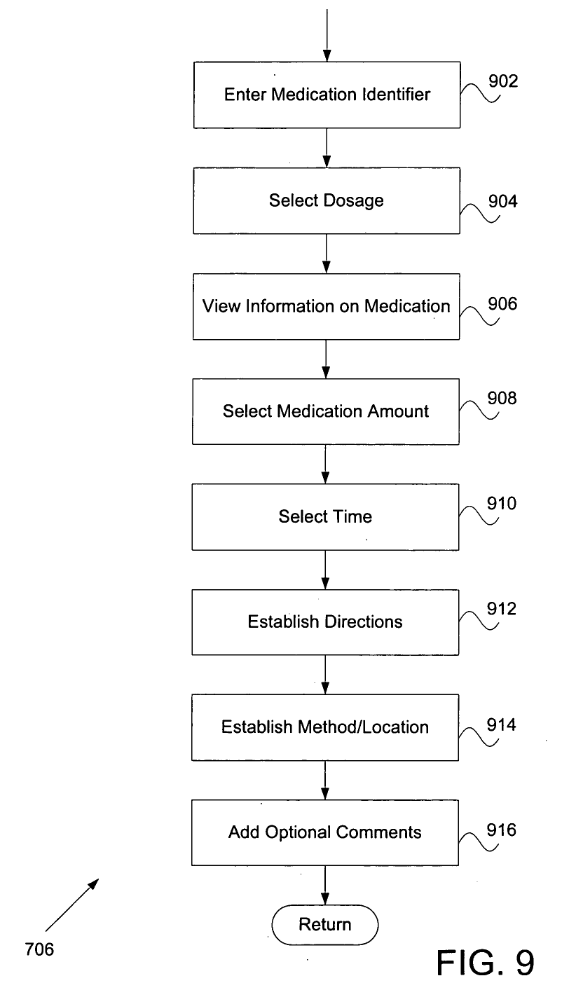

Patient personal medication and food supplement data is then created in step 706. In this step, the participant may enter new medications into the system for the patient or update medication information (e.g., reffills). This step will be discussed in more detail in connection with FIG. 9.

The crossover and allergic reaction test (DUR) is applied in step 708 and a determination is made as to if at least one medication needs to be changed based on the results of the crossover and allergic reaction test (DUR) in step 710. If at least one medication needs to be changed, then the participant repeats the steps of creating the patient personal medication and food supplement data (step 706) and applying the crossover and allergic reaction test (DUR) (step 708). However, if no medications need to be changed, then the participant may create or update the patient personal administrative data in optional step 712. Steps 708 and 710 will be discussed in more detail in connection with FIG. 10.

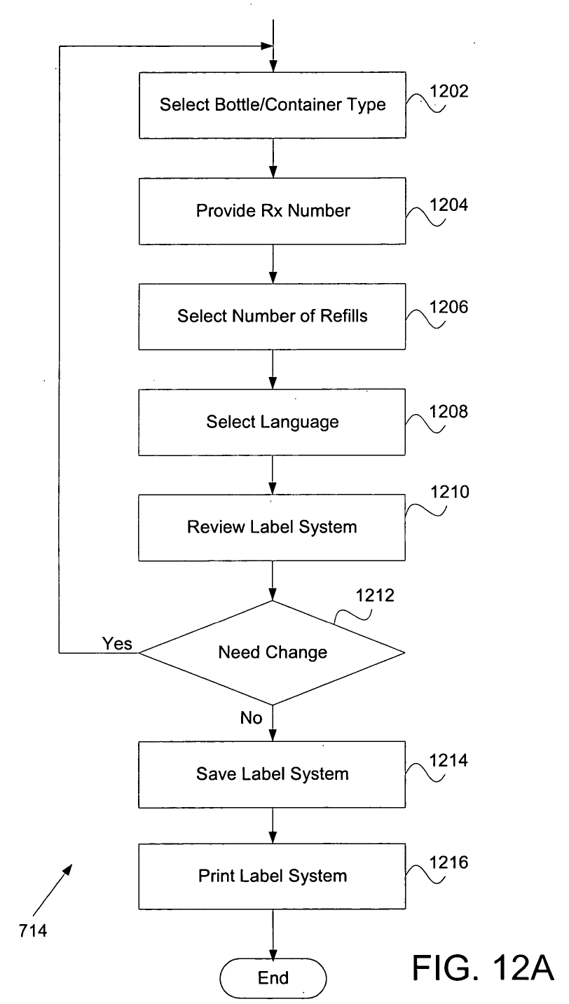

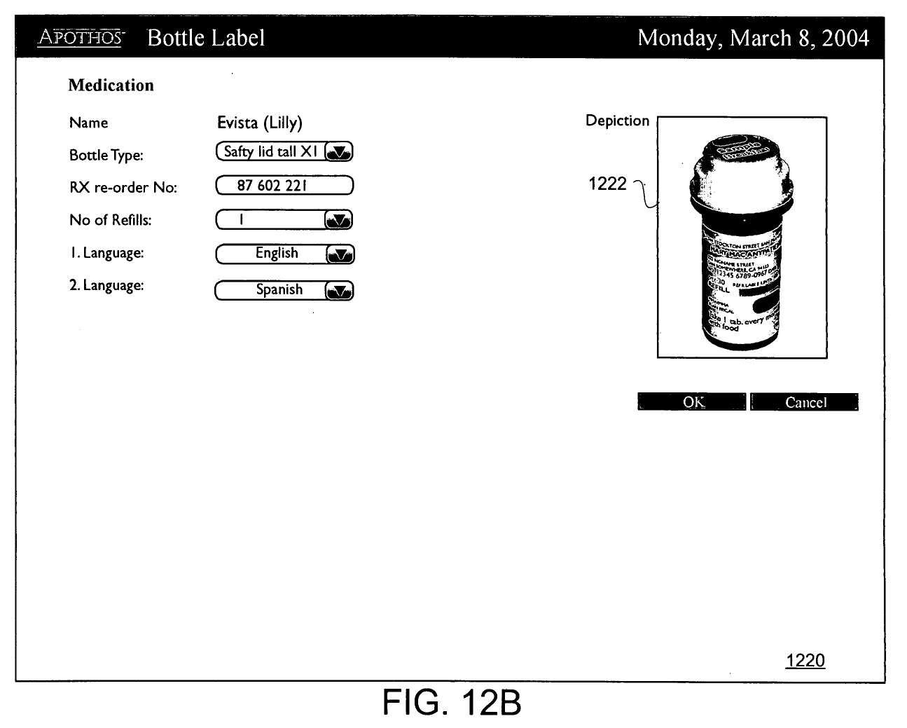

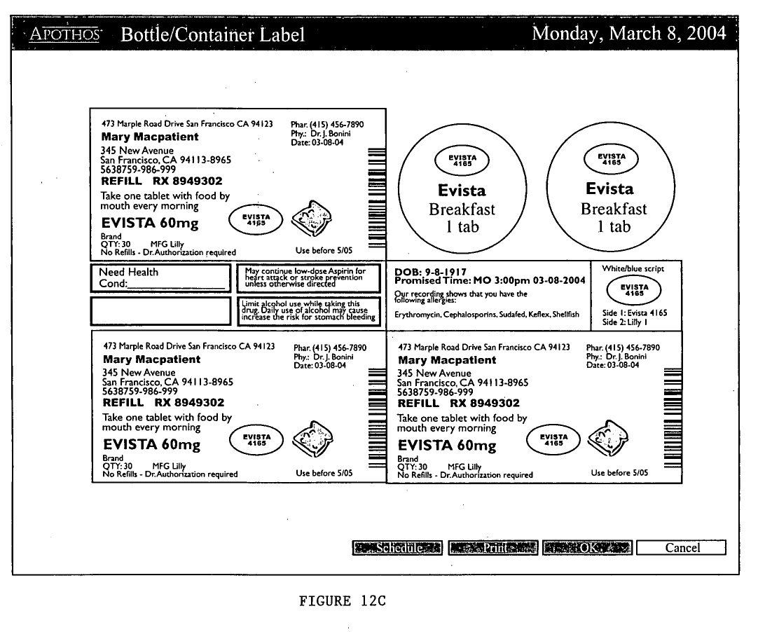

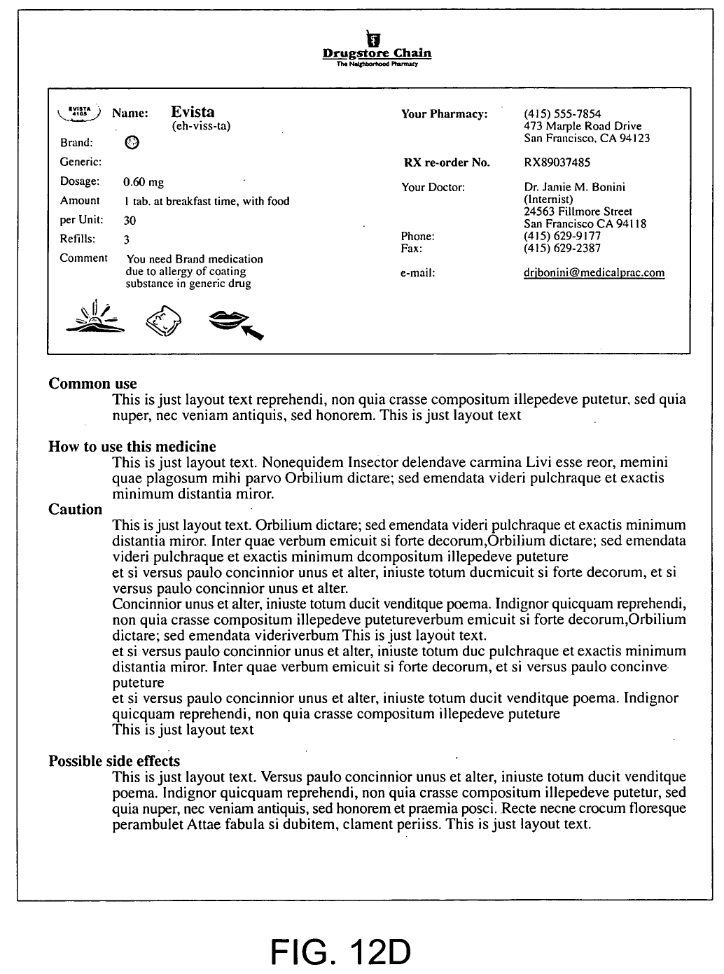

In step 714, the label system is generated. A more detailed discussion on the generation of the label system is provided in connection with FIGS. 12A-12D below. In a further step, the corresponding schedule 640 (FIG. 6C) may be generated.

It should be noted that the method of FIG. 7 is exemplary. Alternative embodiments may perform more, less, or alternative steps to achieve the same results. For example, checking the availability of the patient's data file (i.e., step 702) may not be required in an embodiment where the computing system 204 is the local or network server. Additionally, some steps may be practiced in a different order or not practiced. For example, if the participant merely wants to generate and print a refill label system without prescribing a new medication, the crossover and allergic reaction test of steps 708 and 710 may not need to be practiced. Further to this example, step 706 only accesses stored medication and food supplement data. Alternatively, steps 708 and 710 may still need to be applied to insure that any new updates and safety regulations by the FDA are not ignored and that the medication is safe to be allocated.

Referring now to FIG. 8, an exemplary flowchart for handling patient personal profile data is shown. According to one embodiment, the computing system 204 (FIG. 2) checks if the patient's personal profile data is available in step 802. If the profile data is available, then the personal profile data file is accessed in step 804. The participant may then view the data in the profile data file. If changes and updates are needed in step 806, the participant may input and save the changes in step 808.

Should the personal profile data file not be available in step 802, the participant will create a new profile data file in step 810 via the profile data unit 502 (FIG. 5). Accordingly, the participant may be prompted to enter data such as the patient's picture, medical history, encoded Social Security Number, file number, and other pertinent information. Based on the information, the patient's personal profile data file is established.

Referring now to FIG. 9, an exemplary flowchart of a method for creating patient personal medication and food supplement data (step 706) is provided. The medication and food supplement data file is created and updated by the medication and food supplement data unit 504 (FIG. 5) and uses information from the medication and reference picture library 512 (FIG. 5). The medication and food supplement unit 504 processes information such as name of the medication, dosage(s), amount(s), directions, times(s) of allocation, and so forth. Resultantly, the medication and food supplement unit 504 establishes a list of medications and food supplements to be administered to the patient.

Accordingly in step 902, a medication identifier is entered for a new or refill prescription by the participant. The medication identifier is associated with a specific medication. For example, the medication identifier may be the name or sku number of a brand or generic medication. If the medication identifier is not entered correctly or is not known to the medication and food supplement data unit 504, the participant will be prompted to reenter the medication identifier. In exemplary embodiments, the medication reference and picture library 512 (FIG. 5) is referenced to determine if the medication identifier is correct.

If the medication identifier is entered correctly, the participant is then prompted to select a dosage (e.g., 5 mg) for the medication in step 904. Preset dosages from which the participant may select from (e.g., scroll down list, select one list) may be provided by the medication reference and picture library 512. Alternatively, the participant may provide the dosage by manually entering the dosage into the computing system 204, for example, via the keyboard 324 (FIG. 3).

After the dosage is selected, information concerning the medication is provided in step 906. In one embodiment, images or drawings of the medication/food supplement and a short description of usage appears on the monitor/screen/display 320 (FIG. 3). The images can appear in one or more angles, be enlarged, and be animated for 360 degree viewing. In a further embodiment, an optional automated voice feature pronounces the medication name and may give the participant a brief description of usage. The information is provided to ensure that the correct medication is selected which will be inserted into the label system and corresponding schedule. One example of a medication information page is shown in FIG. 12D. The images, brief descriptions, and other information are provided by the medication reference and picture library 512.

In step 908, the participant selects the medication amount (e.g., number of tablets or ml). Preset amounts from which the participant may select from may be provided by the medication reference and picture library 512. Alternatively, the participant may provide the amount by manually entering the amount into the computing system 204. In this instance, the participant is able to establish an irregular or customized amount.

The participant selects time(s) that the medication should be administered in step 910. The time(s) may be selected from a preset time(s) selection provided by the medication reference and picture library 512, or may be provided by the participant/physician. In exemplary embodiments, the participant first selects the time(s) of the day to administer the medication. Then, the participant selects the time(s) of the week for medication administration. For example, the medication may be administered at breakfast every other day (see FIG. 6C). In further embodiments, a calendar is provided from which the participant may select days for administering the medication, for example, during customized, irregular times.

In step 912, the participant establishes directions for taking the medication. For example, the medication may need to be taken with food or not taken with alcohol. In one embodiment, the participant may choose to provide easy-to-recognize pictograms (i.e., illustrated symbolized picture) from the medication reference and picture library 512.

In step 914, the participant establishes a method or location of application of the medication or food supplement. For example, the medication may need to be applied to the mouth, the nose, or into the ear. In one embodiment, the participant may choose to provide easy-to-recognize pictograms (e.g., illustrated symbolized picture; see FIG. 6B) from the medication reference and picture library 512. Alternatively or in addition, the participant may provide other directions or comments in step 916. In alternative embodiments, steps 912 and 914 may be encompassed within a single step.

Because the participant has the ability to manually enter customized dosages, amounts, times, and directions, the participant may create an irregular or customized schedule. For example, the participant may schedule medication to be administered in alternating segments of time and/or can be allocated in accordance with any time(s) of the day, time(s) of the week, time(s) of the month, dosage(s), amount(s), and direction(s).

It is noted that FIG. 9 describes one embodiment of the method for creating personal mediation and food supplement data. In alternative embodiments, some steps may be performed in a different order, combined, or not practiced. Additionally, some steps may be automatically performed by the computing system based on information from the medication reference and picture library 512.

Referring now to FIG. 10, an exemplary flowchart of a method for testing for crossover and allergic reaction (steps 708 and 710) is provided. The crossover and allergic reaction test (DUR) performs a check to determine whether there is an incompatible use of two or more medications and food supplements after the list of medications and food supplements have been provided by the participant. In step 1002, one medication is selected for comparison with the rest of the medication on the list. If the selected medication is compatible with the rest of the medication in step 1004, then the crossover/allergic reaction test module 506 (FIG. 5) determines if there is a next medication on the list (step 1006) which needs to be tested for compatibility. If so, then the method returns to the beginning of the test.

If in step 1004, the selected medication is not compatible with one or more of the other medications on the list, a warning is issued in step 1008. Then, the test module 506 will query the participant as to whether at least one of the incompatible medications should be replaced or whether at least one of the incompatible medications should not be prescribed (i.e., refuse prescription) in step 1010. If the participant chooses to refuse prescribing one of the incompatible medications, then the refused medication will be removed from the medication list for the patient in step 1014, and the test module 506 moves on to test a next medication, if one is available. In further embodiments, the refused medication may be replaced with a safe alternative.

If the participant chooses to replace one of the incompatible medications, then an alternative medication is selected in step 1012. In one embodiment, a list of alternative medication may be provided by the medication reference and picture library 512. Alternatively, the participant may manually provide an alternative medication. After the alternative medication is selected, the personal medication and food supplement data is updated and the test module 506 will repeat the test with the alternative medication.

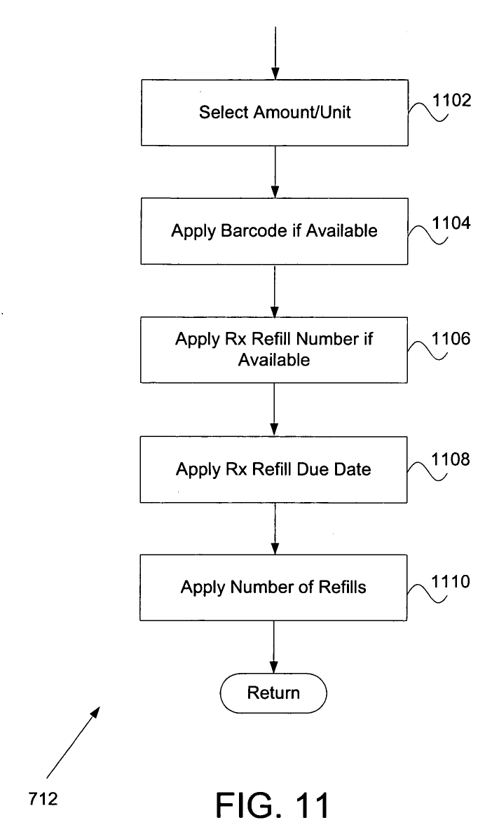

Referring now to FIG. 11, an exemplary flowchart of a method for creating patient personal administrative data is shown. The administrative data is used to ensure both the participant and the patient an efficient and secure future distribution of the medication. According to one embodiment of the present invention, this method is optional when creating a schedule. In step 1102, an amount/unit is selected via the administrative unit. The amount/unit of medication (e.g., per container) may be suggested by the medication reference and picture library 512 (FIG. 5) or entered manually by the participant (e.g., in accordance with a physician's orders).

If a barcode or similar machine-readable identifier for a specific medication on the list is available, the barcode or identifier may be applied in step 1104. The barcode or identifier may be chosen from an existing bar code identifier such as those used by the pharmaceutical industry or provided by the medication reference and picture library 512. Alternatively, an internal custom barcode may be generated by the participant for use with the participants own computing system 204 (FIG. 2). An internal custom barcode may be utilized, for example, when the participant has an internal security barcode system such as those commonly used in hospitals.

In step 1106, the participant applies an Rx refill number if one is available. The Rx refill number may be obtained from the participant's computing system databank. This Rx refill number enables the patient to easily reorder medication, for example, via phone, e-mail, the Internet, or other methods.

In step 1108, the participant applies an Rx refill due date if applicable. The Rx refill due date is the day a patient has to reorder her/his refill of the current prescription. The refill due date represents the last day this medication is available to the patient, if medication is taken properly and according to the physician's orders. The participant may enter the refill due date manually or the computing system may calculate the due date and apply it automatically.

In step 1110, the participant applies a number of refills if available. The number of refills is the number of times the patient may obtain the prescription as prescribed by the physician without a further prescription. The participant may either manually enter the number of refills or retrieves the number of refills remaining from the computing system databank.

Referring now to FIG. 12A, an exemplary flowchart of a detailed method for generating at least one label is provided. In exemplary embodiments, the label is generated by the label module 510 (FIG. 5) of the MPS module 408 (FIG. 4). In step 1202, a bottle/container type is selected onto which the at least one label will be employed. For example, the bottle type may be different for a container having a non-childproof lid than that having a childproof lid. According to one embodiment, the bottle/container type may be chosen from a selection provided by the MPS module 408 via, for example, a scroll through menu. In a further embodiment, the participant may customize the bottle/container type by manually entering a bottle/container type or dimension. In yet a further embodiment, the administrative data unit 514 (FIG. 5) selects the bottle/container type based on the medication or food supplement or it is automatically provided by the medication reference and picture library 512

In step 1204, a prescription (Rx) number is provided. In exemplary embodiments, the Rx number may be provided by the administrative data unit 514, or other component of the MPS module 408 (FIG. 4). Alternatively, the participant may manually enter this number.

The number of refills is then provided in step 1206. In one embodiment, the number of refills is automatically obtained from the medication and food supplement data unit 504 (FIG. 5) for the particular patient. Alternatively, a selection of number of refills may be provided, for example, via a scroll through menu. In a further embodiment, the participant may manually enter the number of refills for the prescription.

Optionally in step 1208, the participant may choose a language for the label system 600. For example, the patient may be blind, and thus the participant will choose to print the label in Braille. The language selection may be manually entered by the participant. Alternatively, a scroll through menu of possible languages may be provided to the participant from which to select. If no language is chosen, then a default language (e.g., the native language of the participant) will be used. In further embodiments, more than one language may be provided. This may be useful, for example, if the patient understands one language and the caregiver understands a different language.

The participant may then review the label in step 1210. A sample of a generated label system comprising a top label and a side label displayed for review is shown in both FIGS. 12B and 12C. In one embodiment, if a determination is made as to whether changes to the label system are needed (step 1212), the participant may reselect the bottle/container type and/or change the Rx number, number of refills, or the language. If no changes are needed, then the label system is saved in step 1214. The label system may then be printed in step 1216. The corresponding schedule 640 (FIG. 6) may also be created in a further embodiment.

It is noted that FIG. 12A illustrates one method for the label system generating step 714. Alternative embodiments may practice the method in a different manner. For example, some steps may be performed in a different order, or some steps may not be necessary. It is further noted that the label system may comprise any number of labels (e.g., one top label, one side label, a combination of a top label and side label, etc.).

Referring now to FIG. 12B, an exemplary user interface 1220 for the label system generation method of FIG. 12A is shown. The user interface 1220 may be provided to the participant, for example, on the monitor/screen/display 320 (FIG. 3) of the computing system 204 (FIG. 2). In the present embodiment, the user interface 1220 automatically provides a name of the medication or food supplement that the label system will be generated for. Scroll through menus are also provided for selecting the bottle/container type, number of refills, and languages. The Rx number may be automatically filled in by the administrative data unit 514 (FIG. 5) or manually entered by the participant. The user interface 1220 may also provide a visual depiction 1222 of what the label system will look like on the selected bottle/container type. It should be noted that the user interface 1220 of FIG. 12B is exemplary. Alternative embodiments may use more, less, or alternative fields to achieve the same results.

Once data fields are completed on the user interface 1220, a sample print sheet is displayed to the participant according to one embodiment of the present invention. FIG. 12C illustrates an exemplary sample print sheet 1230. The sample print sheet 1230 shows how the label system will be printed out. In the present embodiment, three side labels 1232 and two top labels 1234 will be printed. However, alternative embodiments will allow the participant to select the number of side labels 1232 and top labels 1234 to print out. In some embodiments, the sample print sheet 1230 may not be needed, and the participants may directly print the label system from the user interface 1220 (FIG. 12B).

During the label generation process, the participant may access and print a medication information page such as that shown in FIG. 12D. The medication information page may comprise specific information on the medication (e.g., image, dosage, amount to be taken, directions for taking, comments), pharmacy and physician, information, common use, cautions, possible side effects, and patient specific directions ordered by the physician. The medication information page may be accessed, for example, by clicking on a graphical representation of the medication on one of the user interface pages utilized by the participant. The presentation of the medication information page can be varied so as to adapt to a patient's/caregiver's specific needs (e.g., it can be generated in different language, large print, Braille, illiteracy supporting pictograms, or any other way).

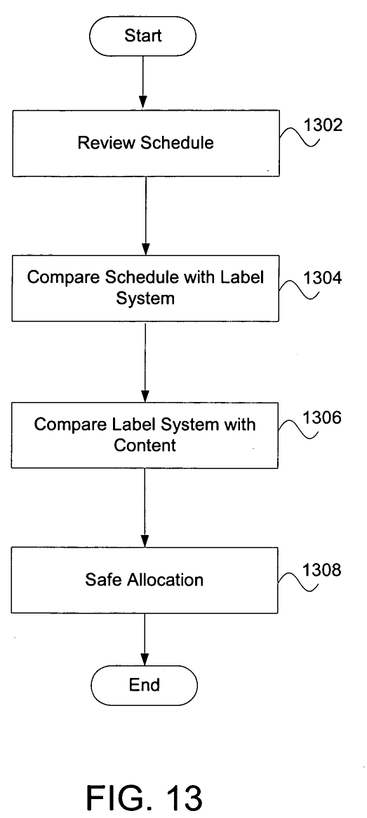

Referring now to FIG. 13, an exemplary flowchart for safely taking the correct medication or food supplement is shown. In step 1302, the patient or caregiver reviews the schedule 640 (FIG. 6C) to determine which medication or food supplement should be currently taken. Ideally, the patient or caregiver will view a matrix on the schedule 640 which illustrates via graphical representations 642 (FIG. 6C) which medication should be currently taken and at which time.

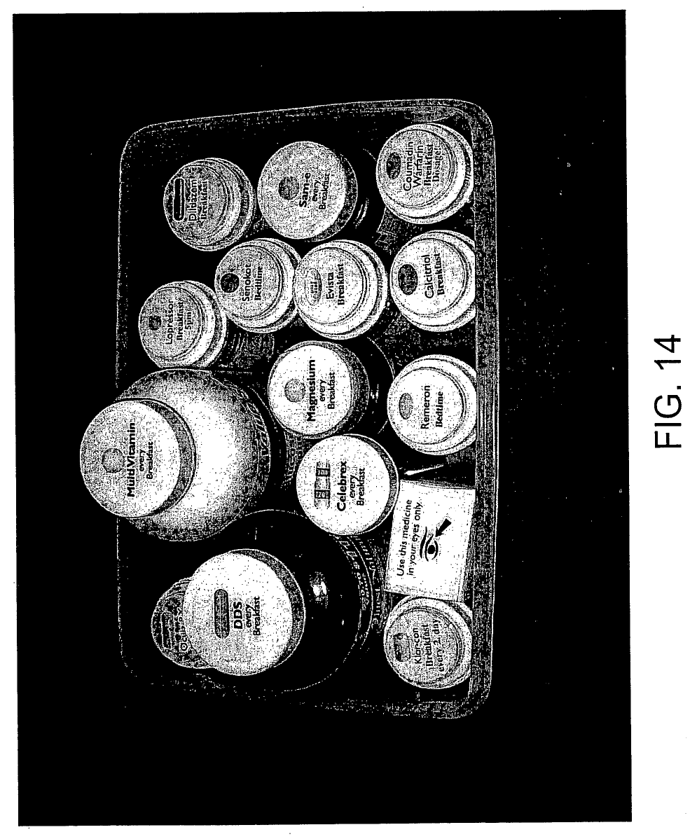

In step 1304, the patient or caregiver compares the graphic representation 642 of the medication or food supplement to be taken with the graphical representation 612 or 626 (FIG. 6A) on the labels of the bottles/containers. For example, if the containers are stacked high on a shelf, the caregiver could compare the graphical representation 642 with the graphic representation 626 on the side label 610 (FIG. 6A). Alternatively, if the containers are packed together such that only the tops of the containers are visible (see FIG. 14), then the graphical representation 642 is compared to graphical representations 612 on the top label 602, 604, 606, or 608 (FIG. 6A).

Once the correct container is identified by the graphical representation (and may be confirmed by comparing the name of the medication), the patient or caregiver may compare the graphical representation 612 or 626 with the content of the container (step 1306). Thus for example, the patient may visually compare the medication within the container with the graphical representation 612 or 626 to insure the correct medication will be taken. If the medication matches the graphical representation 612 or 626, then the medication is safely allocated in step 1308.

Although the present invention has been discussed with respect to specific embodiments, one of ordinary skill in the art will realize that these embodiments are merely illustrative, and not restrictive, of the present invention. For example, although the above description describes an exemplary personal computing system, it should be understood that the present invention relates to computing devices in general and need not be restricted to use in the field of medicine.

1. A system for generating a medication label system for a prescribed medication or food supplement comprising:
a processor;
a profile data unit configured for managing personal data for a patient;
a medication and food supplement data unit configured for managing medication or food supplement data for the patient; and
a labeling module configured to generate the label system based on the personal data and medication or food supplement data, the label system comprising at least a top label providing a graphical representation of the medication or food supplement.

2. The system of claim 1 further comprising a schedule module for generating a corresponding schedule, the corresponding schedule utilizing the same graphical representation.

3. The system of claim 1 further comprising a medication reference and picture library configured for storing and providing information regarding medications and food supplements.

4. The system of claim 3 wherein the information are graphical representations of the medication or food supplement.

5. The system of claim 3 wherein the information are pictograms, the pictograms providing directions for use of the medication or food supplement.

6. The system of claim 1 further comprising an administrative data unit configured for managing administrative data related to prescriptions and refills.

7. The system of claim 1 further comprising a database configured for storing patient data.

8. The system of claim 1 further comprising a network databank server configured for providing data from a central databank.

9. The system of claim 1 further comprising a display for viewing patient data and label system samples.

10. The system of claim 1 wherein the label system further comprises a side label having the graphical representation of the medication or food supplement.

11. A computer readable medium having embodied thereon a program, the program being executable by a machine to perform a method for generating a medication label system for a prescribed medication or food supplement comprising:
accessing patient personal profile data for a patient;
accessing medication or food supplement data for the patient; and
generating a label system based on the patient personal profile data and the medication or food supplement data, the label system comprising at least a top label providing a graphical representation of the medication or food supplement.

12. The computer readable medium of claim 11 wherein the method further comprises generating a corresponding schedule utilizing the same graphical representations.

13. The computer readable medium of claim 11 wherein the method further comprises creating personal administrative data related to a medication or food supplement for the patient.

14. The computer readable medium of claim 11 wherein the method further comprises obtaining patient data from a central databank server.

15. The computer readable medium of claim 14 wherein the method further comprises providing a valid login to the central databank server.

16. The computer readable medium of claim 11 wherein accessing patient personal profile data further comprises generating the patient personal profile data.

17. The computer readable medium of claim 11 wherein accessing the medication or food supplement data further comprises generating the medication or food supplement data.

18. The computer readable medium of claim 11 wherein the method further comprises translating the label system into another language.

19. The computer readable medium of claim 11 wherein the method further comprises translating the label system into Braille.

20. The computer readable medium of claim 11 wherein the method further comprises generating the label system further comprises providing pictograms.

21. A method for generating a medication label system for a prescribed medication or food supplement comprising:
accessing patient personal profile data for a patient;
accessing medication or food supplement data for the patient; and
generating the label system based on the patient personal profile data and the medication or food supplement data, the label system comprising at least a top label providing a graphical representation of the medication or food supplement.

22. The method of claim 21 further comprising generating a corresponding schedule utilizing the same graphical representation as the label system.

23. A pharmaceutical label system for application to a container containing a medication or food supplement comprising:
a top label;
a graphical representation of the medication or food supplement disposed on the top label; and
a name of the medication or food supplement disposed on the top label.

24. The label system of claim 23 further comprising at least one pictogram for providing visual directions for taking at least one of the medication or food supplements.

25. The label system of claim 23 further comprising a bar code configured for scanning.

26. The label system of claim 23 further comprising a side label, the side label having a graphical representation of the medication or food supplement.

27. The label system of claim 26 wherein the side label further comprises at least one pictogram for providing visual directions for taking at least one of the medication or food supplements.

28. The label system of claim 26 wherein the side label further comprises a bar code configured for scanning.

29. A system for safely allocating medication or food supplements to a patient comprising:
a schedule configured to provide a time table as to when at least one medication or food supplement should be taken, the time table utilizing a graphical representation of the at least one medication or food supplement; and
a label system disposed on a container containing one of the at least one medication or food supplement, the label system having a graphical representation of the medication or food supplement contained within the container, whereby the graphical representation on the label system may be compared with the graphical representation on the schedule to insure a correct medication or food supplement is taken.

30. The system of claim 29 wherein the label system further comprises at least one pictogram, the pictogram providing a visual direction for use.

31. The system of claim 29 wherein the label system and the schedule may be translated.
